(19) United States
(12) Patent Application Publication
(10) Pub. No.: US 2025/0073643 A1
(43) Pub. Date: Mar. 6, 2025

(54) MULTI-ELEMENT FILTRATION VESSEL

(71) Applicants: DDP SPECIALTY ELECTRONIC MATERIALS US, LLC, Wilmington, DE (US); ZHEJIANG OMEX ENVIRONMENTAL ENGINEERING CO. LTD, Huzhou, Zhejiang (CN)

(72) Inventors: Steven D. Jons, Edina, MN (US); Bie Li, WuXing, Huzhou City, Zhejiang (CN); Bin He, WuXing, Huzhou City, Zhejiang (CN); Liangzhou Fan, Huzhou, Zhejiang (CN); Shankhadeep Das, Edina, MN (US); Bill Qixiang Cai, WuXing, Huzhou City, Zhejiang (CN)

(21) Appl. No.: 18/560,046

(22) PCT Filed: Feb. 15, 2022
(86) PCT No.: PCT/US2022/016405

§ 371 Date: Nov. 9, 2023

(30) Foreign Application Priority Data
May 12, 2021 (WO) PCT/CN2021/093191

(51) Int. Cl. B01D 63/04

(52) U.S. Cl. CPC B01D 63/046; B01D 2313/025; B01D 2313/06; B01D 2313/54; B01D 2321/185

(57) ABSTRACT

A multi-element filtration vessel included spaced beams for supporting and/or aligning filtration elements from below. The filtration elements have bottom ends adapted to rest upon adjacent support beams and also to extend between them to form a cavity that can capture feed fluid and an aeration gas and conduct it into the filtration element. In another aspect, a multi-element filtration vessel has removable aerators mounted on a projection on the wall of the filtration vessel.

### FIELD OF THE INVENTION

This invention relates to multi-element filtration vessels.

### BACKGROUND

Multi-element filtration vessels are used widely in water treatment facilities to purify water, and also as reactors in various chemical manufacturing processes. Semi-permeable membranes are assembled within elements, which are mounted vertically in an array within the vessel. A feed fluid is often fed upwardly through the elements, where it is separated by the membranes into a concentrate and a permeate. An aerating gas is usually introduced into the vessel at a point below the elements. The aerating gas can perform several useful functions. When the membrane is a hollow fiber type, gas bubbles provide buoyancy, assisting with the transfer of the feed fluid between fibers or through the capillaries in the fibers. The aerating gas also can perform a cleaning function, and improve fluid mixing.

One or more supports within the vessel bear the weight of the elements and maintain them in their proper positions. In some cases, the elements are entirely supported and aligned by an upper plate. In other cases, a lower support is used, typically in conjunction with an upper plate. In these latter configurations, the weight of the elements may be borne by the upper plate alone, in which case the lower support performs only an alignment function; alternatively the weight of the elements is borne by the lower plate (with the upper plate providing alignment) or distributed between the upper plate and lower support, with the lower support also serving to align the bottom ends of the elements.

The lower support typically has taken the form of a perforated plate. The lower ends of the elements can align with the perforations so that the feed fluid and aerating gas can pass from below the lower support and into the elements. A problem with this design is that the perforated plate is often quite massive; large multi-element filtration vessels may have diameters of 1.5 meters or greater. The plate must be very rigid and often quite thick to span such a wide diameter. Very large plates are expensive, difficult to transport and assemble into the vessels, and susceptible to deforming under pressure or weight.

Another problem with using a perforated plate as a lower support is that solid materials such as sludge or particles entrained in the feed fluid tend to settle onto the plate over time. These solids are difficult to remove from conventionally-designed vessels because they have to be partially disassembled (such as by removing elements) to be cleaned. It is possible to introduce additional perforations into the lower support plate to allow the solids to sink to the bottom of the vessel, from which they can be more easily drained. However, adding more perforations further weakens the plate, making it more prone to sagging or even breaking.

### SUMMARY OF THE INVENTION

This invention is in one aspect a multi-element filtration apparatus, the apparatus comprising
a) a pressure vessel;
b) multiple filtration elements, each containing at least one filtration membrane in an interior portion thereof, the multiple filtration elements being disposed substantially vertically within the pressure vessel, the multiple filtration elements each having a bottom end having one or more through-holes that admit a fluid into the interior portion of the filtration element,
c) one or more aerators within the pressure vessel for supplying an aeration gas to the bottom ends of the multiple filtration elements; and
d) a first set of multiple spaced beams mounted on an interior surface of the pressure vessel, the first set of multiple spaced beams being engaged with the bottom ends of the multiple filtration elements such that i) each of the bottom ends is supported by two adjacent spaced beams and extends downwardly between said two adjacent spaced beams, each bottom end by itself or together with the two adjacent spaced beams defining a cavity that provides a feed fluid path for a feed fluid and a gas supplied by the aerator(s) to travel upwardly through the cavity to the through-holes in the bottom end, and ii) fluid passages, separate from the feed fluid paths, extend from above to below each pair of adjacent spaced beams and between the bottom ends of adjacent filtration elements mounted on each pair of adjacent spaced beams.

The lower support design of this invention offers several important advantages. Manufacturing is simplified in many cases because the beams often have a simple geometry. They use less material than the pressure plate, reducing raw material, manufacturing and transportation costs. Transportation is easier because the beams can be shipped separately and assembled into place at the location where the multi-element filtration vessel is to be assembled and used.

The lower support design of the invention also offers operational advantages. Adjacent pairs of beams can act as baffles to direct fluids, and in particular an aeration gas, up to the filtration elements. In addition, gaps between the beams form fluid passages through which sludge and other solids can easily settle down through the lower support to the bottom of the pressure vessel, from which they are easily removed.

In a second aspect, the invention is a filtration element comprising
a) an elongated body portion comprising an exterior shell defining an interior portion that contains at least one filtration membrane;
b) a top end affixed to and in fluid communication with the elongated body portion, the top end comprising separate openings for the removal of concentrate and permeate from the filtration element; and
c) a bottom end affixed to the elongated body portion, the bottom end being adapted to rest upon an adjacent pair of beams and to extend downwardly between the adjacent pair of beams and, by itself or together with the adjacent pair of beams form a cavity, the cavity being in fluid communication with the interior portion of the elongated body portion.

In a third aspect, the invention is a filtration apparatus comprising
a) a pressure vessel;
b) multiple filtration elements, each containing at least one filtration membrane in an interior portion thereof, the multiple filtration elements being disposed substantially vertically within the pressure vessel, the multiple filtration elements each having a bottom end having one or more through-holes that admit a fluid into the interior portion of the filtration element, and
c) one or more aerators within the pressure vessel for supplying an aeration gas to the bottom ends of the multiple filtration elements, wherein the one or more aerators are each removably and sealingly mounted onto a protrusion provided on an exterior surface of the pressure vessel and inserted through an opening through the protrusion and the exterior surface of the pressure vessel and into the pressure vessel.

### BRIEF DESCRIPTION OF THE DRAWINGS

FIG. 1 is a front view, in section, of an embodiment of a filtration apparatus of the invention.

FIG. 1A is a side view, in section, of the embodiment of the filtration apparatus shown in FIG. 1, being rotated 90° about a central vertical axis.

FIG. 2 is a top sectional view, taken along lines 2-2A of FIG. 1, of an embodiment of a filtration apparatus of the invention.

FIG. 3A is an isometric view of an embodiment of spaced beams mounted on a peripheral support, for use in this invention.

FIG. 3B is an isometric view of a second embodiment of spaced beams mounted on a peripheral support, for use in this invention.

FIG. 3C is an isometric view of a third embodiment of spaced beams mounted on a peripheral support, for use in this invention.

FIG. 4 is a side view of an embodiment of a beam for use in the invention.

FIG. 5A is front view of a portion of an embodiment of a filtration element for use in the invention.

FIG. 5B is a front view of a portion of a second embodiment of a filtration element for use in the invention.

FIG. 6 is a side view, in section, of an embodiment of a filtration element for use in the invention.

FIG. 7A is an isometric view of an embodiment of a beam with integrated aerator for use in the invention.

FIG. 7B is a sectional view of the beam with integrated aerator shown in FIG. 7A.

FIG. 8 is a side view, partially in section, showing the operation of a beam with integrated aerator.

FIG. 9 is a side view, partially in section, showing the operation of an embodiment of an aeration system for use in the invention.

FIG. 10 is a side sectional view of a filtration apparatus of the third aspect of the invention.

FIG. 11 is a bottom view, in section, taken along lines 11-11A of FIG. 10.

FIG. 12 is a side view of a removable aerator for use in the third aspect of the invention.

FIG. 13 is a side view, in section, of a means of removably attaching a removable aerator to a pressure vessel.

FIG. 14A is a bottom sectional view showing the insertion of an embodiment of a branched removable aerator into a pressure vessel in accordance with the invention.

FIG. 14B is a bottom sectional view showing the branched removable aerator of FIG. 14A when fully inserted into a pressure vessel.

### DETAILED DESCRIPTION OF THE INVENTION

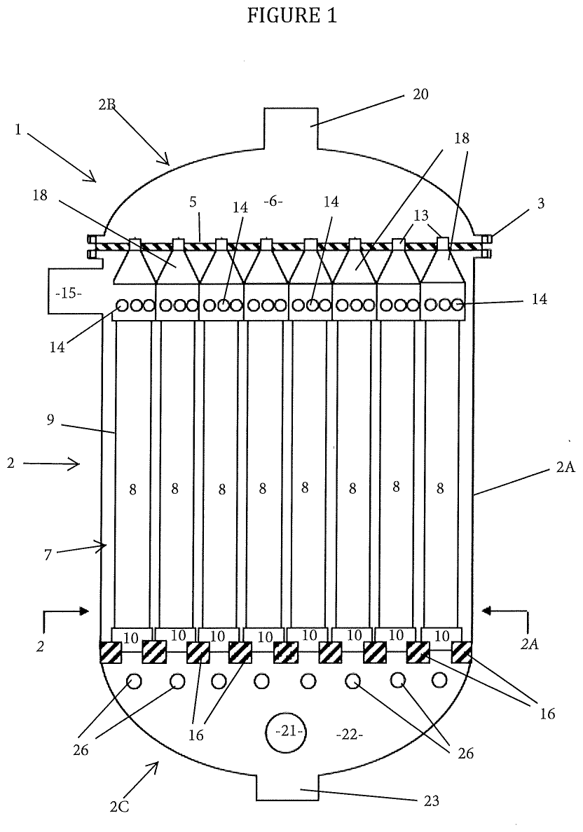

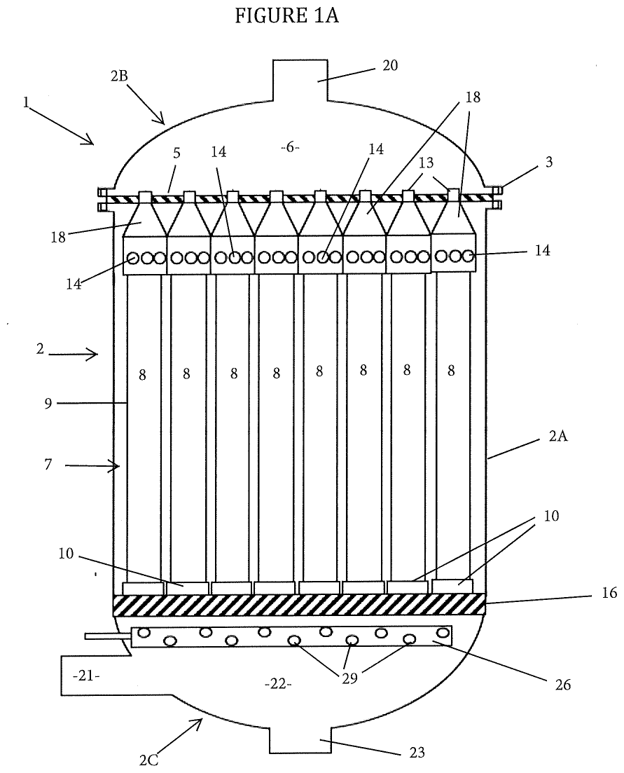

Turning to FIGS. 1 and 1A, multi-element filtration apparatus 1 includes pressure vessel 2, illustrated in cross-section, and formed of a central section 2A and upper and lower sections 2B and 2C. Preferably, the pressure vessel is cylindrical and suitable for operation with inside pressures exceeding at least two bars above the outside pressure. As shown, upper section 2B is mounted to central section 2A via flange joint 3, and lower section 2C is mounted to or integral with central section 2A. Upper support 5 is mounted within pressure vessel 2 to provide support and alignment for filtration elements 8 and to separate upper chamber 6 from main chamber 7. In the embodiment shown, the periphery of upper support 5 is clamped and sealed between the central and upper sections 2A and 2B of pressure vessel 2 at the region of flange joint 3. Lower section 2C and central section 2A can be similarly clamped and sealed. Feed inlet port 21 permits a feed fluid to be introduced into main chamber 7 (as shown, at a level below the level of bottom ends 10 of filtration elements 8) for filtration within filtration apparatus 1.

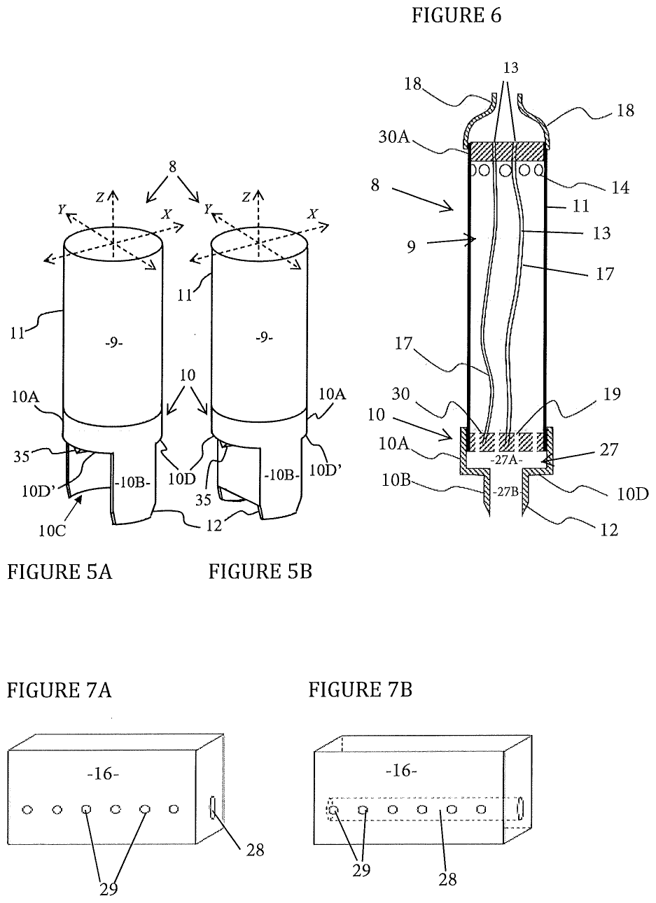

In FIGS. 1 and 1A, multiple filtration elements 8 are located within main chamber 7, engaged with upper support 5, and are supported by a first set of multiple spaced beams 16. The multiple filtration elements generally include a body portion 9 defined by tubular shell 11 (as shown in FIGS. 5 and 6), a top end 18 and a bottom end 10. One or more filtration membranes such as hollow fiber membranes 17 (FIG. 6) reside within body portion 9. The filtration membranes are affixed at or near top end 18 and at or near bottom end 10, typically via tube sheets 30 and 30A (FIG. 6) or in another suitable manner adapted for the specific type of filtration membrane.

Each filtration membrane may be, for example, a microfiltration membrane, ultrafiltration membrane, a nanofiltration membrane or a reverse osmosis membrane. Filtration apparatus 1 may contain, for example, 2 to 150 or more filtration elements 8, with 40 to 75 being an especially useful number of elements for many applications. In other preferred embodiments, the number of filtration elements 8 within a pressure vessel 2 may be selected from 55, 61, 73, 85, 91, 97, 119, or 131. In a preferred embodiment, the filtration membranes take the form of hollow fiber membranes 17 (FIG. 6), but they can be spiral wound or have other configurations if desired.

One or more bottom through-holes 19 (FIGS. 5 and 6) through tube sheet 30 permit the feed fluid and aeration gas to enter body portion 9 through bottom end 10. The feed fluid is separated into a permeate and a concentrate (or reject) by passing through filtration membrane(s) such as hollow fiber membranes 17 in (shown in FIG. 6) residing within body portion 9.

Top ends 18 are adapted to keep the permeate and concentrate separate so they can be removed separately from filtration elements 8 and pressure vessel 2. Hollow fiber membranes 17 preferably are operated in an outside-in manner, in which the feed fluid is fed to the outside of the hollow fiber membranes 17 and permeate passes to the interior lumens 13 of hollow fiber membranes 17. In the embodiment shown in FIG. 6, hollow fiber membranes 17 penetrate through tube sheet 30A, allowing permeate to leave body portion 9 of filtration elements 8 through lumens 13 of hollow fiber membranes 17 and flow into upper chamber 6. When other membrane configurations are used, through-holes are provided at top end 18 of filtration elements 8 to discharge permeate into upper chamber 6. Fluid is removed from upper chamber 6 via a discharge port such as upper discharge port 20.

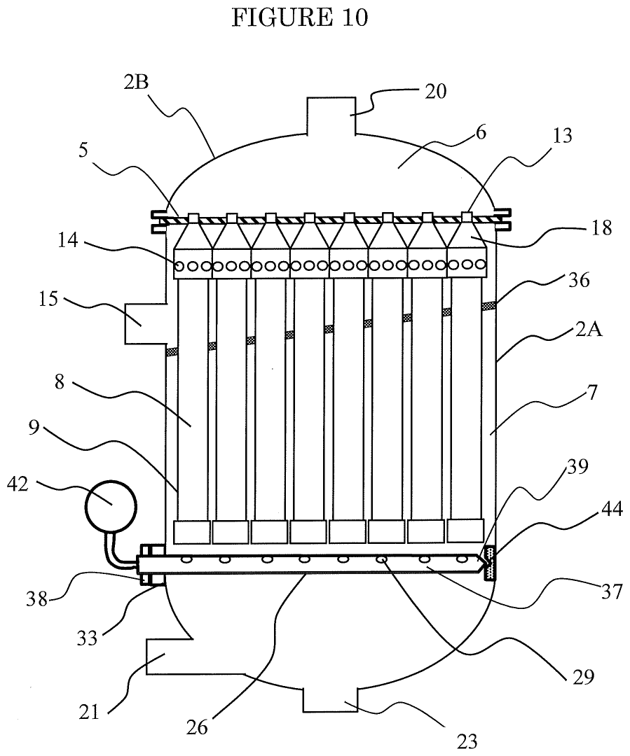

Similarly, discharge openings 14 allow concentrate to leave body portion 9 of filtration elements 8 and be discharged into main chamber 7. Fluid is removed from main chamber 7 via a discharge port such as discharge port 15. The discharge port can also be near the middle or the lower part of main chamber 7. A canted plate such as canted plate 36 of FIG. 10 may be provided to direct concentrate to upper discharge port 15 and to avoid mixing concentrate with feed fluid within lower portions of main chamber 7. If present, canted plate 36 is provided with openings to allow filtration elements 8 to pass through, and in such a case, canted plate 36 can also perform an alignment and/or support function.

Aeration gas (usually air) typically vents from filtration elements 8 with the concentrate and is vented from pressure vessel 2 from a suitable vent (not shown) or through a concentrate discharge port through which the concentrate is removed from pressure vessel 2.

Top ends 18 of filtration elements 8 are generally adapted to engage with openings in upper support plate 5 to form a seal and, via lumens 13 or other through-holes, provide one or more fluid flow paths through upper support plate 5 into upper chamber 6. Top ends 18 may include a cap or connector that is affixed to tubular shell 11 mechanically (e.g., by threads promoting a radial or axial O-ring seal), by use of suitable adhesives, or otherwise, in such a manner as to produce a seal between the cap or connector and tubular shell 11.

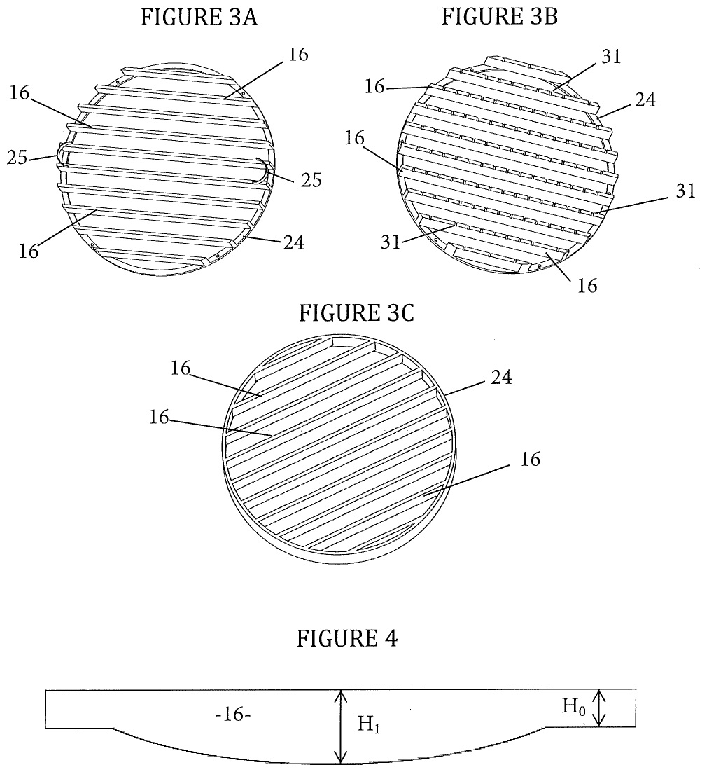

A first set of multiple spaced beams 16 are mounted onto an interior surface of pressure vessel 2. The spaced beams 16 can be mounted on a ridge or other mechanical support structure within pressure vessel 2. The spaced beams 16 can be mounted permanently, such as by an adhesive or through welding them into place, or they may be mounted in a removable manner. The spaced beams 16 preferably are arranged parallel to each other, but non-parallel arrangements may be useful for particular arrangements of filtration elements 8 within pressure vessel 2. The spaced beams 16 can be individually mounted within pressure vessel 2 or may be assembled into an alignment structure such as the peripheral supports 24 shown in FIGS. 3A, 3B, and 3C. The alignment structure can align and hold beams 16 together, creating a unitary structure.

Spaced beams 16 can have any convenient cross-sectional geometry provided the beams engage with bottom ends 10 of filtration elements 8 as described herein. A simple rectangular cross-section is entirely suitable, although spaced beams 16 can have alternative cross-sectional geometries such as squares, triangles, trapezoids, hexagons, other regular or irregular polygons, I-beams and circles. The cross-section of any beam 16 may vary along its length as shown, for example, in FIG. 4 where beam 16 has a greater height (H₁) in the middle than at the ends (H₀). The various beams 16 do not all need to have the same geometry or dimensions. For example, beams 16 that pass close to the center of pressure vessel 2 are longer and generally bear more weight and for that reason may be made thicker and/or taller than other beams 16 that are positioned nearer to the sides of pressure vessel 2. Longer beams may be reinforced or supported in some manner to accommodate a greater load. It is also possible to use different materials of construction for the various beams 16 to accommodate their respective loads.

The materials of construction of spaced beams 16 are selected to meet their mechanical requirements. Examples of suitable materials of construction include metals such as steel, stainless steel, aluminum or magnesium, polymers (such as polyvinyl chloride, a polyester or a polyolefin) and reinforced organic polymers such as fiber-reinforced thermoplastic or thermoset resins. To avoid corrosion, metal materials may be encapsulated within a polymeric coating. A preferred material for at least the longer center beams is a fiber-reinforced thermoplastic or thermoset resin.

Bottom ends 10 of filtration elements 8 each are adapted to rest upon an adjacent pair of beams 16 and to extend downwardly between those adjacent beams 16. The spacing of each adjacent pair of beams 16 preferably is chosen in conjunction with the geometry of bottom ends 10 of filtration elements 8 so that bottom ends 10 fit snugly within the space between adjacent beams 16.

As illustrated in FIGS. 5A and 5B, the lower section 10B of bottom ends 10 may be tapered inwardly to facilitate positioning and alignment between beams 16. Preferably, the taper makes an angle of between 15 and 75 degrees, more preferably between 30 and 60 degrees, with the vertical in the X-Z plane, where X is the direction from shoulder 10D to opposing shoulder 10D′.

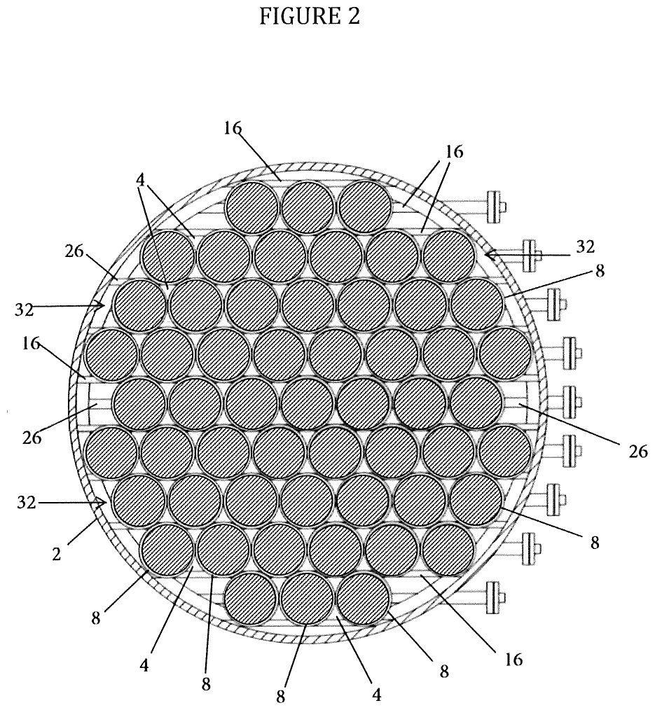

The filtration elements 8 can be arranged within pressure vessel 2 in any convenient manner. They may be arranged in an array or other defined pattern, or randomly. In a preferred embodiment such as is shown in FIG. 2, the filtration elements 8 are arranged in a hexagonal close packing arrangement, as this enables facile support of each row 32 (FIG. 2) of multiple filtration elements 8 by two adjacent spaced beams 16. With elements arranged in hexagonal close packing, adjacent parallel rows 32 of multiple filtration elements 8 can be supported by a common beam 16 and the adjacent beams 16 on either side of the common beam 16.

Optional positioning elements such as brackets 25 in FIG. 3A and alignment notches 31 in FIG. 3B may be incorporated or affixed to beams 16 to align filtration elements 8 and prevent them from moving in the direction of beams 16 i.e., along the space defined by the two adjacent beams 16 on which the particular filtration element 8 rests. In preferred embodiments, beams 16 and bottom ends 10 of filtration elements 8 have corresponding positioning elements that engage and/or otherwise mate with each other to align filtration elements 8 into a fixed position relative to the beams 16 to which it engages. For example, embodiments illustrated in FIGS. 5A and 5B illustrate that shoulders 10D may include canted downward protrusions adapted to engage with notches 31 of beams 16 (FIG. 3B). Such a canted downward protrusion may form an angle of between 15 and 75 degrees, more preferably between 30 and 60 degrees, with the beam direction Y and a vertical Z of the corresponding filtration element 8.

When positioned within pressure vessel 2, bottom ends 10 of filtration elements 8 by themselves or together with the two adjacent beams 16 define a cavity such as cavity 27 of FIG. 6. Cavity 27 provides a fluid path for feed fluid and a gas supplied by aerators 26 to travel upwardly through cavity 27 to one or more through-holes 19 that admit the feed fluid and aerating gas into the interior of the corresponding filtration element 8.

FIG. 5A illustrates a bottom end 10 of filtration element 8 adapted to define such a cavity by itself. Bottom end 10 has an upper section 10A, which is wider than lower section 10B, shoulders 10D being formed at the conjunction of upper section 10A and lower section 10B. Shoulders 10D rest on adjacent beams 16, while lower section 10B extends downwardly between such adjacent beams 16. Bottom end 10 defines cavity 27 (FIG. 6). Cavity 27 provides significant operational advantages as much or all of the aeration gas is captured with it, from which the aeration gas percolates upwards through through-holes 19 into body portions 9 of filtration elements 8, leading to an efficient circulation of aeration gas and feed fluid through filtration elements 8 as well as a more uniform distribution of the aeration gas between filtration elements 8. Gas outlet holes 29 of aerator 26 in some embodiments are aligned with cavities 27 or even positioned within cavities 27 so as to permit aeration gas to flow directly into cavities 27, further increasing the efficiency of aeration gas utilization.

In the embodiment shown in FIG. 6, cavity 27 includes an upper cavity 27A and a lower cavity 27B. As shown, upper cavity 27A resides above the level of beams 16 and may function as a headspace for the aeration gas provided by aerators 16. The headspace may have a vertical extension of at least 0.5 cm or at least 1 cm, and, for example, up to 10 cm or up to 5.1 cm. Lower cavity 27B extends between the adjacent beams.

FIG. 5B illustrates a bottom end 10 adapted to form a cavity together with adjacent beams 16. In this configuration, lower section 10B has one or more open sides 10C. When in place, adjacent beams 16 abut lower section 10B on each open side, thereby producing lower cavity 27B.

In embodiments such as shown in FIGS. 5A, 5B, and 6, lower section 10B has tapered lower section 12. During loading, an element that is approximately positioned between adjacent beams 16 can be nudged (in a direction approximately perpendicular to the beams 16) into a more correct position through interaction of the tapered lower section 12 with a beam 16. Tapered lower section 12 may make an angle of between 15 and 75 degrees, and more preferably between 30 and 60 degrees, with both the vertical axis (Z) of the element and with the element width direction (X). In this way, the lower section 10B of an element is made more easily able to be positioned in place between adjacent beams 16.

The specific design of bottom end 10 in FIGS. 5A, 5B and 6 is not necessary. Alternative bottom end geometries are entirely suitable provided bottom end 10 is supported by adjacent spaced beams 16 and extends downwardly between the adjacent spaced beams 16, and the bottom end by itself or together with the adjacent beams forms a cavity 27 that provides a feed path for a feed fluid and a gas supplied by the aerator 26 to travel upwardly through cavity 27 to the through-holes 19 in the bottom end 10.

As shown in FIG. 2, filtration elements 8 are positioned along the lengths of adjacent beams 16 in such a manner that fluid passages 4, (separate from the feed paths through cavities 27), extend from above to below each pair of adjacent spaced beams 16 and between the bottom ends of adjacent filtration elements 8 mounted on each pair of adjacent spaced beams 16. An advantage of this feature is that solid particles that may accumulate in main chamber 7 can pass through fluid passages 4 to lower portion 22 of main chamber 7, from which they can be removed easily.

Optionally, a second set of multiple spaced beams is provided, being oriented at an angle to and intersecting with first set of multiple spaced beams 16 to form a grid. The grid may define openings to receive bottom ends 10 of filtration elements 8 and fluid passages 4 between filtration elements, the fluid passages 4 extending from above to below multiple spaced beams 16 (as well as from above to below the second set of multiple spaced beams). Such a grid pattern may contribute added mechanical strength as well as serve as positioning means for the bottom ends 10 of filtration elements 8.

Aerators 26 are provided to supply an aeration gas to bottom ends 10 of multiple filtration elements 8. By “aerator” it is meant any device that produces gas bubbles when an aeration gas is flowed into the aerator and out into lower portion 22. A gas sparger or other device with small openings (such as gas outlet holes 29 in FIGS. 1A and 7) that cause bubbles to form is entirely suitable. The openings preferably have dimensions of at least 0.25 mm, at least 0.5 mm or at least 1 mm and up to 10 mm, up to 7.5, up to 5 mm, or up to 4 mm. The aeration gas may be air, oxygen, nitrogen, helium, argon or other material that is gaseous at standard temperature and pressure, or a mixture of any two or more of such gasses.

Aerators 26 are positioned below and/or within cavities 27 so gas bubbles emitted by aerators 26 are captured within cavities 27 and transported with feed fluid through bottom through-holes 19 and into filtration elements 8. Aerators 26 may be aligned under rows 32 of filtration elements 8 positioned between adjacent pairs of beams 16, as shown in FIGS. 1 and 2; in such a case aerators 26 may be aligned generally parallel to and between each adjacent pair of beams 16. Gas outlet holes 29 (such as illustrated in FIGS. 1A and 7) in aerators 26 may be positioned directly beneath or within cavities 27 so gas bubbles emitted from aerators 26 are directed into cavity 27. These gas outlet holes 29 may be directed upward, downward, or at an angle to a side of the aerator 26.

Optionally, one or more aerators 26 are positioned below the spaced beams 16 and each aerator 26 provides air bubbles to the cavities 27 of two adjacent rows 32 of filtration elements 8, as shown in FIG. 9. Preferably, holes in one or more aerators 26 are arranged so that all, or at least 50% or at least 90%, of the aeration gas that is released into the pressure vessel accumulates within cavities 27, especially upper cavities 27A (FIG. 6) before entering the corresponding filtration element 8 through one or more through-hole(s) 19.

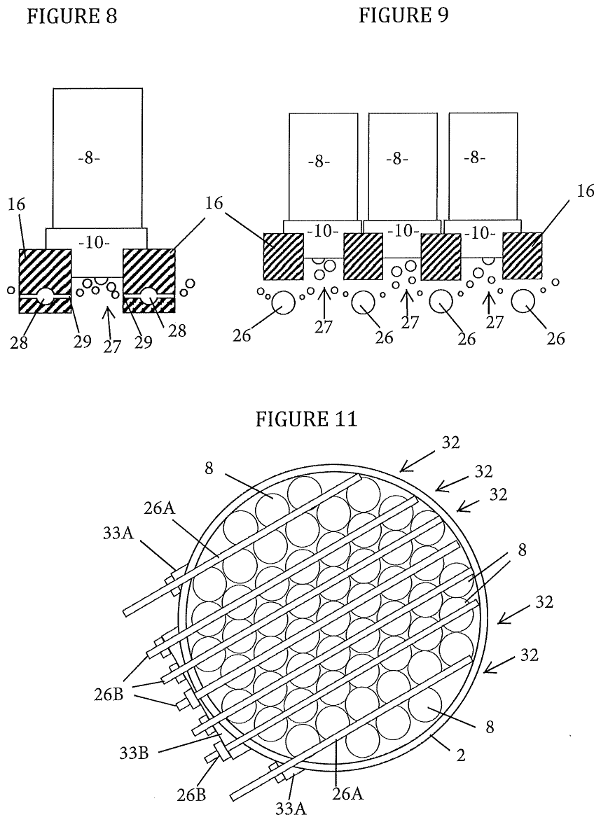

Aerators 26 may be consolidated with or incorporated into multiple beams 16 (or a second set of multiple beams, if present) as shown, for example, in FIGS. 7A, 7B and 8. In FIGS. 7A, 7B and 8, beam 16 includes longitudinal channel 28 through which an aeration gas is supplied to gas outlet holes 29. An aeration gas supplied to beam 16 passes through longitudinal channel 28 and is delivered to gas outlet holes 29, from which (FIG. 8) the aeration gas passes into cavity 27 formed by bottom end 10 of filtration element 8, or by bottom end 10 of filtration element 8 and adjacent beams 16.

In another embodiment, aerators 26 may be attached to sidewalls of beams 16. A preferred system of aerators 26 includes a plurality of parallel elongated tubes 40 arranged below the filtration elements, such as the arrangement shown in FIGS. 1 and 2. Preferably, each such elongated tube 40 is arranged parallel to a row 32 of filtration elements 8 and at an angle of approximately 0° or 60° to beams 16.

In the third aspect of the invention, aerators 26 are removably mounted within pressure vessel 2. Preferably, each aerator 26 is removable from and reinsertable into pressure vessel 2 for cleaning, replacement or other maintenance, without a need to remove any filtration element 8 from pressure vessel 2. In a particular embodiment, removable aerators 26 are mounted onto protrusions 33 (FIGS. 10-14) provided on the outer surface of pressure vessel 2. An opening 34 extends through protrusion 33 and pressure vessel 2 for inserting aerator 26 through protrusion 33 and into lower portion 22 of main chamber 7. Protrusion 33 may be or include a flange, which may, for example, present a flat face for mating with one or more aerators 26. A single protrusion such as protrusion 33B in FIG. 11 may serve to mount multiple aerators 26 if desired.

Removable aerators 26 are sealably mounted onto protrusion 33, via an attachment means (which may be mechanical or otherwise, such as a nut-and-bolt assembly, a sealing plate, various types of clamping devices and the like) that allows for detachment and reattachment. Preferably, one or more non-permanent and replaceable sealing means such as axial and radial seals 45 (FIG. 13) are formed between pressure vessel 2 and aerator 26. Non-limiting examples of sealing means include O-rings, gaskets, and stoppers.

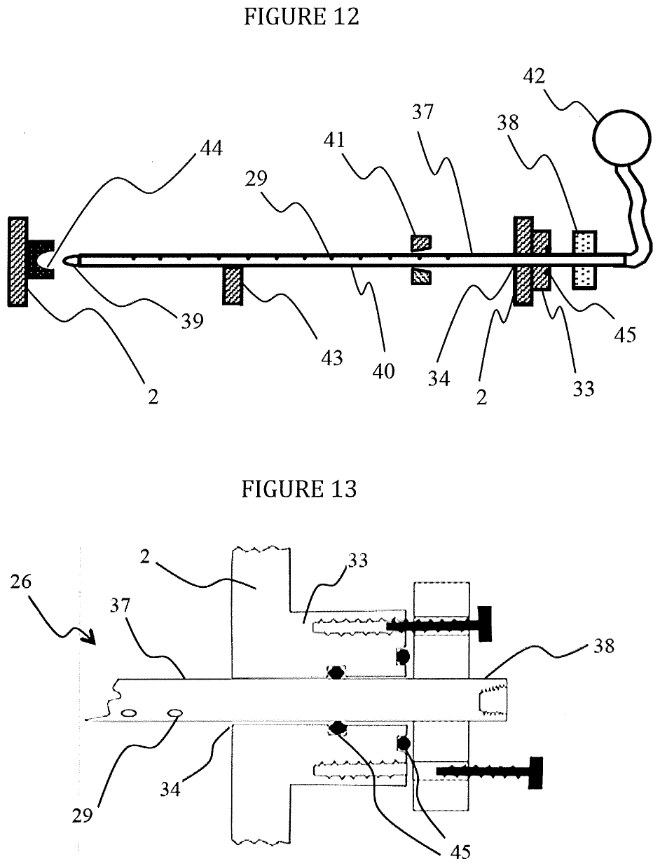

Removable aerators 26 may include a section 38 that is exterior of pressure vessel 2, and another section 37 having gas outlet holes 29 that extends into the interior of pressure vessel 2. The entire inner section is adapted to fit through opening 34 for insertion and removal. Removable aerators 26 preferably are closed at distal end 39. Removable aerators 26 preferably also include a releasable connection for engaging and sealing to an external gas source, potentially via a manifold 42 (FIGS. 10 and 12). Manifold 42 may be used to connect multiple aerators 26 the external gas source.

In one embodiment, removable aerators 26 may comprise an elongated pipe 40 which is generally self-supporting as it extends across the pressure vessel 2. The distal end 39 of removable aerator 26 is located on an opposite side of lower chamber 7 from opening 34, and is preferably near the opposing pressure vessel wall. One or more additional supports for removable aerator(s) 26 may be provided within pressure vessel 2 to maintain the desired alignment and/or to provide mechanical support to prevent sagging, bending, or unwanted motion during operation. For instance, a removable aerator 26 may be supported at both sides of lower chamber 7. In one embodiment, removable aerator 26 may have a sealed end that engages with a positioner (such as a distal constraint 44 in FIG. 12) located on (or near) pressure vessel 2 and at a position opposite opening 34. Distal end 39 may be tapered to facilitate alignment and engaging with distal constraint 44 to position aerator 26 correctly. One or more aerator supports 43 may be located within lower chamber 7 (and away from the pressure vessel walls). Alignment jigs 41 (FIG. 12) may interact with removable aerator 26 to constrict its motion along a path and facilitate positioning removable aerator 26 within lower chamber 7.

Aerators 26 of the first aspect of the invention may be removable and reinsertable as described herein.

A removable aerator may be used to best advantage when the pressure vessel contains a plurality of filtration elements 8 arranged in row 32, and removable aerators 26 extend parallel to the rows. In some embodiments, some or all of removable aerators 26 are located below one or more rows 32 of filtration elements 8, and gas outlet holes 29 are arranged to be positioned under each individual filtration element 8 in the corresponding row 32. One or more removable aerators 26 may be located between two adjacent rows 32 of filtration elements 8, the gas outlet holes 29 being arranged to provide air to elements in the two adjacent rows 32 on each side of that aerator. Both of these configurations are illustrated in FIG. 11, wherein removable aerators 26A are located between two adjacent rows 32 of filtration elements 8 and removable aerators 26B each are positioned below a row 32 of filtration elements 8.

Each removable aerator 26 advantageously services a similar number of elements. Preferably, multiple removable aerators 26 extend into pressure vessel 2 and no aerator services more than 50% more, more preferably more than 25% more, elements than any other removable aerator 26 in pressure vessel 2.

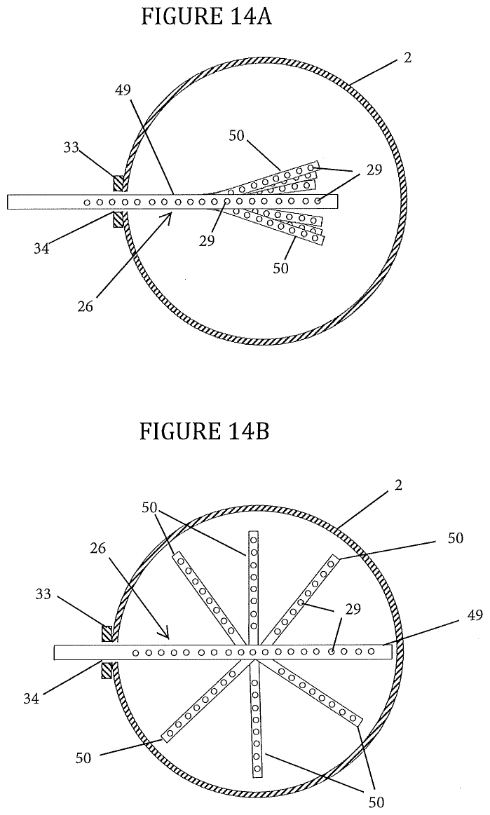

Aerators 26 may be linear or branched. In embodiments in which aerators 26 are removable and branched, the branches preferably are attached to a linear main section and can be bent (if flexible) or otherwise folded (if mounted via one or more joints or other moveable connections) toward the linear main section for insertion and removal, as shown in FIGS. 14A and 14B. Thus, for example, a branched removable aerator 26 may have a fishbone or umbrella type of assembly, in which the branches are foldable toward a linear main section for insertion into and removal from pressure vessel 2. In the embodiment shown in FIGS. 14A and 14B, removable aerator 26 includes linear main section 49. Branches 50 are pivotably mounted onto main section 49. During insertion, branches 50 are folded so they closely align with linear main section 49, so removable aerator 26 can be inserted through opening 34 in protrusion 33 and pressure vessel 2. As shown in FIG. 14B, after insertion branches 50 then are extended outwardly to create a two- or three-dimensional branched structure within pressure vessel 2. Branches 50 then are inwardly foldable toward linear main section 49 for removal of removable aerator 26 from pressure vessel 2 through opening 34.

It is not necessary to use removable aerators 26 together with spaced beams as in the first aspect of this invention. Removable aerators 26 can, if desired, be used in conjunction with a conventional lower support in the form of a perforated plate, or which lack a lower support for filtration elements 8.

Multi-element filtration apparatus 1 may further include various auxiliary apparatus such as pumps, valves, seals, instrumentation, piping, ductwork and the like as may be desirable or useful. An intermediate barrier such as a canted plate with holes 36 for filtration elements 8 may be provided within main chamber 7 to direct concentrate to discharge port 15, thereby preventing or reducing intermingling with the feed fluid.

During operation, a feed fluid is introduced into pressure vessel 2 of multi-element filtration apparatus 1 via feed inlet port 21. Pressure vessel 2 is filled at least to the level of bottom ends 10 so feed fluid enters filtration elements 8 through cavities 27 in bottom ends 10 and passes through through-holes 19 to enter into the interior portions of filtration elements 8. An aeration supply system (not shown) supplies pressurized gas to aerators 26. The aeration gas bubbles upward through cavities 27 and through-holes 19 to enter filtration elements 8.

Upon entering interior portions of filtration elements 8, aeration gas and feed fluid travel upward through filtration elements 8, coming into contact with the filtration membranes, where the feed fluid is separated into a permeate that passes through the membrane and a concentrate or reject that includes some portion of the feed fluid and one or more materials that are rejected by the membrane and are thus prevented from passing through it. The permeate and concentrate are taken separately from at or near top ends 18 of filtration elements 8. In the embodiment shown in FIG. 1, for example, permeate can be withdrawn from filtration elements 8 through lumens 13, that extend through tube sheet 30A (FIG. 6), collected in upper chamber 6 of pressure vessel 2, and removed via upper discharge port 20. Concentrate and aeration gas are discharged from filtration elements 8 through discharge openings 14, with concentrate being removed from pressure vessel 2 via discharge port 15. Aeration gas can be vented through discharge port 15 or a separate air vent (not shown).

In the case of hollow fiber membranes operated in an outside-in manner, the aeration gas and feed fluid are supplied to and contacted with the exterior surfaces of the hollow fiber membranes 17. A portion of the fluid passes through the hollow fiber membranes 17 and into their respective lumens to produce the permeate, the concentrate in that case being that portion of the feed fluid that does not pass through and into the hollow fibers.

Particulate matter that accumulates within main chamber 7 falls under force of gravity to the bottom of main chamber 7, where it passes through fluid passages 4 into lower portion 22 of main chamber 7. Particulate matter accumulating in lower portion 22 of main chamber 7 is easily removed, such as, for example, by taking a purge stream out of pressure vessel 2, such as via bottom drain 23. Particulate matter may include, for example, solid material that has accumulated on the membrane surface and has been removed, solid materials carried in with the feed fluid; solids materials that may precipitate during the filtration process or otherwise within pressure vessel 2; biological matter such as algae, bacterial colonies, mold and the like that may grow within pressure vessel 2; rust particles, scale, and the like. The ability to remove this particulate matter is an important advantage of the first aspect of this invention.

The multi-element filtration apparatus of the invention is useful for filtering a wide variety of fluids, especially aqueous fluids such as groundwater, surface water, seawater, process streams from chemical operations and/or power generating stations, as well as many others. In a particular embodiment, the multi-element filtration apparatus is a seawater ultrafiltration and/or microfiltration apparatus, and can be used, for example, as a prefilter for preparing seawater for reverse osmosis to produce potable water.

1. A multi-element filtration apparatus, the apparatus comprising
a) a pressure vessel;
b) multiple filtration elements, each containing at least one filtration membrane in an interior portion thereof, the multiple filtration elements being disposed substantially vertically within the pressure vessel, the multiple filtration elements each having a bottom end having one or more through-holes that admit a fluid into the interior portion of the filtration element;
c) one or more aerators within the pressure vessel for supplying an aeration gas to the bottom ends of the multiple filtration elements;
d) a first set of multiple spaced beams mounted on an interior surface of the pressure vessel, the first set of multiple spaced beams being engaged with the bottom ends of the multiple filtration elements such that i) each of the bottom ends is supported by two adjacent spaced beams and extends downwardly between said two adjacent spaced beams, each bottom end by itself or together with the two adjacent spaced beams defining a cavity that provides a feed fluid path for a feed fluid and a gas supplied by the aerator(s) to travel upwardly through the cavity to the throughholes in the bottom end, and ii) fluid passages, separate from the feed fluid paths, extend from above to below each pair of adjacent spaced beams and between the bottom end caps of adjacent filtration elements mounted on each pair of adjacent spaced beams.

2. The multi-element filtration apparatus of claim 1, wherein each bottom end comprises an upper portion that resides above the adjacent spaced beams and a lower portion that extends downwardly between the two adjacent spaced beams on which the bottom end is supported, wherein the upper portion defines an upper portion of the cavity that extends above the two adjacent spaced beams.

3. The multi-element filtration device of claim 1 further comprising at least one upper support for aligning the multiple filtration elements.

4. The multi-element filtration device of claim 1 wherein the filtration membrane is a hollow fiber membrane.

5. The multi-element filtration device of claim 1 further comprising a feed inlet port for introducing a feed fluid into the pressure vessel; a permeate discharge port for discharging from the pressure vessel a permeate produced by the multiple filtration elements, and a concentrate discharge port for discharging from the pressure vessel a concentrate produced by the multiple filtration elements.

6. The multi-element filtration device of claim 1 wherein the first set of multiple spaced beams is mounted onto an alignment structure that aligns beams and forms a unitary structure.

7. The multi-element filtration device of claim 1 further comprising positioning elements for engaging with and positioning the multiple filtration elements in a fixed position on the first set of multiple spaced beams.

8. The multi-element filtration device of claim 1 wherein the one or more aerators are integrated with the first set of multiple spaced beams such that an aeration gas is supplied to the cavities through gas outlets in the first set of multiple spaced beams.

9. The multi-element filtration device of claim 1 wherein the one or more aerators are removable aerators.

10. A filtration element comprising
a) an elongated body portion comprising a shell defining an interior portion that contains at least one filtration membrane;
b) a top end affixed to and in fluid communication with the elongated body portion, the top end comprising separate openings for the removal of concentrate and permeate from the filtration element; and
c) a bottom end affixed to the elongated body portion, the bottom end being adapted to rest upon an adjacent pair of beams and to extend downwardly between the adjacent pair of beams and, by itself or together with the adjacent pair of beams form a cavity, the cavity being in fluid communication with the interior portion of the elongated body portion.

11. The filtration element of claim 10 wherein the bottom end has an upper section and a lower section, the upper section being wider than the lower section and defining shoulders at the conjunction of the upper section and lower section for resting on an adjacent pair of beams, and the lower section being adapted to extend downwardly between such adjacent pair of beams.

12. The filtration element of claim 11 wherein the upper section defines an upper cavity that resides above the level of the adjacent pair of beams and the lower section by itself or together with the adjacent pair of beams defines a lower cavity that extends between the adjacent beams.

13. A filtration apparatus comprising
a) a pressure vessel;
b) multiple filtration elements, each containing at least one filtration membrane in an interior portion thereof, the multiple filtration elements being disposed substantially vertically within the pressure vessel, the multiple filtration elements each having a bottom end having one or more through-holes that admit a fluid into the interior portion of the filtration element, and
c) one or more removable aerators extending into the pressure vessel for supplying an aeration gas to the bottom ends of the multiple filtration modules,
wherein the one or more removable aerators are each removably and sealingly mounted onto a protrusion provided on an exterior surface of the pressure vessel and through an opening through the protrusion and the exterior surface of the pressure vessel and into the pressure vessel.

14. The filtration apparatus of claim 13 wherein each removable aerator includes (i) an interior section positioned within said pressure vessel, the section comprising an elongated conduit closed at a distal and having multiple holes down a longitudinal axis for supplying an aeration gas to the bottom ends of the multiple filtration elements, and further wherein the interior section is adapted to fit through the opening and (2) an opening to the exterior of the pressure vessel adapted to connect the removable aerator to a source of an aeration gas; the filtration apparatus further comprising d) sealing means to seal the aerator to the protrusion, and an attachment means located at least partially on the protrusion to fix the aerator position within the pressure vessel.

15. The filtration apparatus of claim 14 wherein the multiple filtration elements are arranged in a plurality of parallel rows within the pressure vessel, and the inner section of each aerator extends in a direction parallel to said rows.
